(19) United States
(12) Patent Application Publication
(10) Pub. No.: US 2018/0054987 A1
(43) Pub. Date: Mar. 1, 2018

(54) Mobile Climate Controlled Indoor Algae Farm

(71) Applicant: RICHARD M. BERMAN, Houston, TX (US)

(72) Inventor: RICHARD M. BERMAN, Houston, TX (US)

(21) Appl. No.: 15/611,368

(22) Filed: Jun. 1, 2017

(51) Int. Cl. A01G 33/00; A01G 7/04; A01G 7/02

(52) U.S. Cl. CPC A01G 33/00; A01G 7/02; A01G 7/045

(57) ABSTRACT

A mobile climate controlled indoor structure deploying multiple modular and scalable devices for continuous indoor production of algae biomass is disclosed.

### FIELD OF THE INVENTION

The invention concerns a mobile indoor climate controlled Algae Farm deploying multiple proprietary devices, Biogae, for dependable, reliable, predictable, scalable and sustainable continuous production of high yield algae biomass to be used with non-invasive methods to remediate contaminated water for reuse on oil and gas drilling sites.

### BACKGROUND OF THE INVENTION

Supplying large quantities of water, replenishing contaminated water, hauling off contaminated water, disposing of contaminated water and remediation of contaminated water have become a cause of concern, risk and expense for operators utilizing frac methods and other highly water intensive forms of oil and gas exploration and production.

It is a goal of the invention to address the need of removing toxic materials such as lead, cadium, mercury, scandium, tin, arsenic, bromine and bacteria such as salmonella, shigella and other coliforms, on the same site as exploration and productions activities, while reducing overall water costs of present replacement, hauling off, replenishing, disposal and remediation procedures.

Energy companies used nearly 250 billion gallons of water to extract unconventional shale gas and oil from hydraulically fractured wells in the United States between 2005 and 2014. (Duke Today, Duke University, Sep. 15, 2015)

Fracked oil wells generate about half a barrel of wastewater for each barrel of oil, while conventional oil wells on land generate more than three barrels of wastewater for each barrel of oil produced. (Duke Today, Duke University, Sep. 15, 2015)

Algae biomass has been used to commercially treat wastewater since at least 1950. The lack of commercial quantities algae biomass is an on going problem due to sustainability, reliability, predictability, scalability and contamination of the most prevalent current production methods of algae growth. Specifically, using outdoor algae production techniques.

Current production methods include open-pond methods, in which algae are grown in shallow flooded pits that are open to the environment. Such methods create substantial water losses due to evaporation. Yet, the National Renewable Energy Laboratory estimates that even these inefficient methods could produce enough algae for the production of sixty billion gallons per year of biodiesel at a water cost of no more than 120 trillion gallons per year. (“The Potential for Biofuels From Algae,” Philip Pienkos, Ph.D., Algae Biomass Summit, Nov. 15, 2007; see http:/www.nrel.gov/docs/fy080sti/42414.pdf).

As previously mentioned, outdoor open-pond production methods for algae are inefficient because they are subject to open evaporation. These methods also suffer because there is no control over other environmental factors, such as the availability of sunlight and temperature. Thus, this approach to algae biomass production offers no ability to ensure even remotely optimal growing conditions.

As an alternative to open ponds, algae growers have sought to control the evaporation factor by laying serpentine lengths of transparent tubing in open fields and pumping a solution of algae and nutrients through the tubing. This method overcomes the evaporation problem, but remains subject to uncontrollable variations in temperature and sunlight. Additionally, required pumps add expense to such a system, and are subject to maintenance requirements. The tubing is also subject to rapid aging due to direct exposure to the ultraviolet components of sunlight, and represents an added expense when it must be replaced, both in the cost of the tubing and the downtime for the production plant.

Outdoor production facilities also suffer from an additional handicap, because they rely on sunlight to provide the light for the algae to photosynthesize, a process that must occur if the algae are to grow. Therefore, these facilities are essentially single-layer systems; they cannot be “stacked” because the upper levels would block sunlight from the lower ones. This factor means that outdoor production facilities are relegated to the old-style fanning model, that is, production per acre can only be increased by increasing the efficiency of the growing process. As discussed above, there are severe limitations in these cases to improve the growing efficiency.

Other attempts have been made to bring the growing process indoors, and also to “stack” the flow path vertically, rather than laying it along the ground. For example, U.S. Pat. No. 7,536,827 (“the '827 patent”) discloses an indoor system of sluices that are racked vertically with a slight downslope to each sluice, so that a mixture of nutrient and algae may be propelled downward by gravity from the topmost (insertion) sluice, through each lower sluice in turn to the lowermost (harvest) sluice. Lighting under the bottom of each sluice may be used to provide light to the growing algae in the sluice below.

This mobile indoor system has several advantages over outdoor systems. The problem of sunlight variation has been effectively eliminated, and the indoor nature of the assemblage allows for environmental control of temperature and factors such as the CO2, content of the atmosphere. Additionally, because the sluices are racked vertically, this system uses height as well as surface area for production, alleviating some of the inefficiency in land use of the outdoor systems. The gravity-feed system avoids the need for pumps to move the algae-nutrient mixture. Accordingly, the disclosure of the '827 patent represents an improvement over outdoor systems.

However, the device of the '827 patent retains certain inefficiencies. The necessarily large length required to grow the algae to sufficient size for harvesting, coupled with the necessary downslope for each sluice, requires a structure whose total height requires a custom building to house it. In fact, the '827 patent contemplates just such a structure. Moreover, the support assembly required to maintain the sluices in vertical alignment with each other represents a sizeable material cost, together with the contemplated pipage for such needs as warm-water heating if needed to maintain the desired temperature of the algae-nutrient mixture.

It is a goal of the invention to provide an economically sound device and mobile system for growing and harvesting algae under controlled indoor conditions.

It is further another goal of the invention to provide a means for growing and harvesting algae that is scalable due to its modular design.

It is yet another goal to provide a means for growing and harvesting algae that requires a special mobile indoor structure to provide an indoor climate controlled environment to be produce algae biomass, that can be operable anywhere in the world where power to operate an external transformer is available.

### SUMMARY OF THE INVENTION

The invention uses a proprietary mechanical apparatus called Biogae, and a method of operating said Biogae that provides a high yield of algae under controlled indoor conditions. Biogae comprises a cylindrical tank, preferably sized so that it will fit inside an available building space, although a larger cylindrical tank requiring a customized containment facility would not depart from the spirit of the invention. A fluid mixture of water, nutrients, and algae is provided and fed into the production zone of the tank.

Because it is intended that Biogae will be used in both indoor stationary and mobile climate-controlled buildings, maintaining the proper temperature of the nutrient-algae mixture should not require the use of heating or cooling devices to control the liquid temperature.

Algae are photosynthetic, and require light to grow. To insure adequate light distribution throughout Biogae, a preferred embodiment of Biogae comprises one or more lamps depending on the size of the Biogae. In one embodiment of the invention, tubes of glass or another transparent material with one sealed end are inserted into the nutrient-algae mixture with their open end remaining in air. Fluorescent lights are inserted into the tubes to provide even lighting of the interior of the vessel. It is preferable to position the lamps with their longitudinal axes aligned substantially with the long axis of Biogae. If more than one lamp is required due to the size of Biogae, it is preferable to space the lamps within the vessel to provide substantially uniform illumination throughout Biogae. As those of skill in the art will understand, the lamps may be frequency adjustable, or frequency specific to provide most, or all, of their light output at frequencies providing the highest rate of growth for the strain of algae being grown. Light Emitting Diode (LED) bars are used for growth of specific algae strains where their use is indicated as more beneficial. Specifically these algae strains respond more favorably to LED lighting than florescent lighting. Biogae utilizes both types of lighting, but not at the same time.

Additionally, it is desirable to provide agitation within Biogae to keep the algae circulating as they grow. Doing so aids in providing a uniform distribution of the algae throughout the nutrient-algae mixture. Agitation may be provided by one or more fan or propeller-type rotating devices avoiding the use of expensive pumps.

As the algae grow, larger algae can “shade” smaller algae from the illumination, thus potentially retarding the growth of the smaller algae. It is therefore desirable to periodically filter larger algae from the nutrient-algae mixture, either by chemical or mechanical filtering. The filtering process draws the larger algae down into a lower zone from which the algae can be extracted. As algae and fluid arc removed from Biogae, additional algae, water, and nutrients are added to the upper zone to continue the growing process. This method allows the growth process to be continuous, so that the production of algae is not interrupted during the extraction phase. Additionally, multiple Biogae's of this design may feed grown algae into a centralized harvest and extraction system, minimizing loss of production should it be necessary to take a Biogae unit off line for maintenance.

Once extracted from the Biogae, the algae are separated from the water by well-known techniques. The algae biomass may then be processed to create a variety of products, including food products and to remediate water causing its reuse by non-invasive methods.

### BRIEF DESCRIPTION OF THE DRAWINGS

FIG. 1A is a schematic side view of one embodiment of the invention.

FIG. 1B is a schematic top view of one embodiment of the invention.

### DETAILED DESCRIPTION OF DRAWINGS

Biogae comprises an upper production zone into which is placed a mixture of nutrients, water, and algae strain. Algae grow in the upper zone, and when of sufficient size and density are filtered into the lower zone for harvesting.

An agitator rotates to provide general mixing of the algae-nutrient fluid. Those of skill in the art will recognize that the size, shape, and rotational speed of the agitator are matter of engineering choice, and may vary depending on the strain of algae grown.

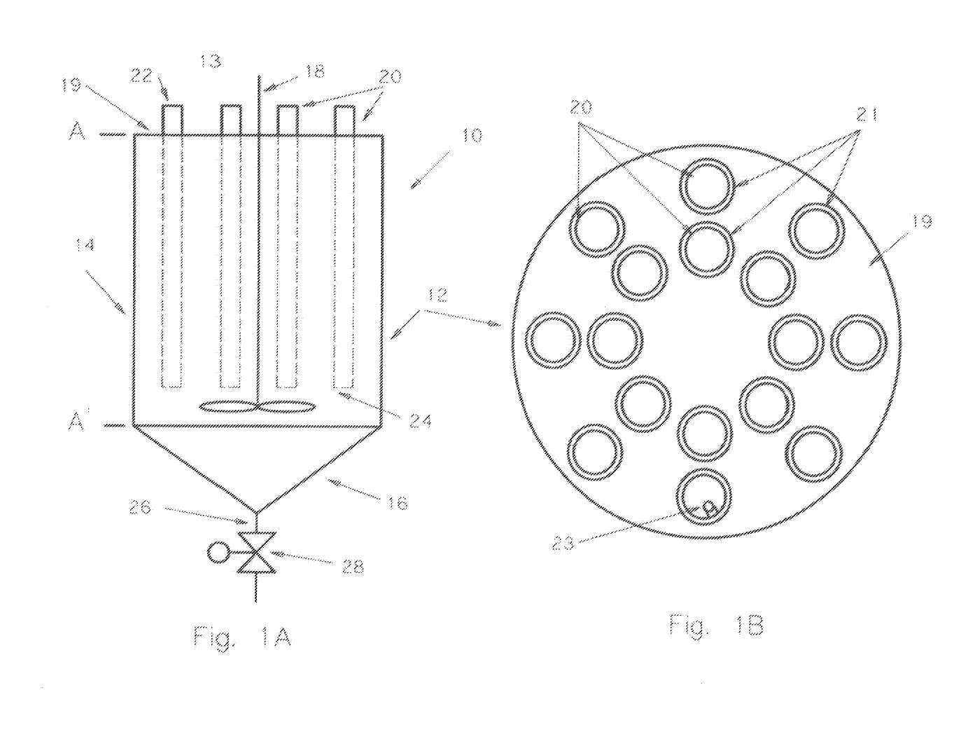

Transparent tubes, the number of which may vary according to optimal conditions specified per each specific algae strain, comprise an open end and a sealed end, and extend into the algae nutrient mixture. Light fixtures (not shown), preferably comprising florescent and Light Emitting Diode (‘LED”) tubes are inserted into transparent tubes to provide general illumination throughout the upper zone of Biogae providing the light needed by algae for photosynthesis. As reflected in the top view of FIG. 1B, transparent tubes may be arrayed about the interior of Biogae in a manner to provide substantially uniform illumination within Biogae.

Those of skill in the art will recognize that factors such as lighting duty cycles and the frequencies of the light used are matters of engineering choice, and optimizing such factors will likely vary depending on the strain of algae grown.

Algae additionally require carbon dioxide to grow. Depending on engineering choice, it may be desirable to provide a means of injecting carbon dioxide into the algae nutrient mixture to promote growth. Atmospheric carbon dioxide may provide a sufficient source of algae to grow. However, leaving the algae nutrient fluid exposed to ambient air increases the risk of harmful contamination. Accordingly, it is preferred that Biogae comprise a lid (FIG. 1B), and that transparent tubes pass relatively tightly through holes in FIG. 1B. Gaskets (not shown) may be provided to improve the sealing relationship between holes and transparent tubes.

Those of skill in the art will recognize that various systems for injecting carbon dioxide into a fluid mixture are known, and that if one is desired, its construction will be a matter of engineering choice.

Biogae may thus optionally be provided with a selectively openable gas inlet to allow for carbon dioxide injection. For example, selectively openanable gas inlet may pass though the side of one of the transparent tubes below the level of lid (FIG. 1B), allowing carbon dioxide to be introduced into Biogae. To prevent interference with the agitation of the fluid, the carbon dioxide feed is preferable directed toward the outside wall of Biogae. However, a variety of other configurations may be used, such as providing a gas inlet through the wall of Biogae.

When algae are of sufficient size and density, they are filtered out of the algae nutrient mixture wither by chemical or mechanical means, the techniques of which are blown to those skilled in the art. These larger algae are filtered into the lower harvesting zone of Biogae, where they are removed from Biogae via outlet line controlled by a valve. As removal occurs, additional algae nutrient water mixture is added to the upper zone of Biogae allowing Biogae to operate in a continuous production mode.

After removal from Biogae algae are processed first by separating them from the water and any nutrient remaining therein, then by further processing as desired. The water and nutrients can be recycled for reuse, whereas discharging the water is not necessary in Biogae.

Those of skill in the art will recognize that the above descriptions are by way of example only, and are not considered to limit the scope of the invention as claimed.

1. A system and device for the continuous indoor production of algae biomass consisting of:
a mobile climate controlled indoor Algae Farm;
multiple proprietary algae production devices;
Algae Farm is a registered trademark, (Reg. U.S. Pat. No. 4,038,939, Registered Oct. 11, 201, Int. Cl.: 1) owned by Richard M Berman, Houston, Tex.;

2. The mobile climate controlled indoor Algae Farm is non-specific with regard to dimensions which are determined by the amount of algae desired to grow and harvest daily, rather its specific purpose is to provide a mobile, portable power contained (by an external power transformer) indoor environment sufficient to grow and harvest algae into algae biomass on site locations, where it is desirous to use non-invasive methods to remediate and reuse water that has been commonly contaminated by waste, frac or other water intensive drilling exploration and production activities associated with the oil and gas industries.

3. The Biogae is a proprietary modular and scalable device for growing and harvesting any specific strain of algae in a mobile climate controlled indoor Algae Farm, comprising an upper production zone and a lower harvesting zone, a transparent enclosure positioned at least partially within said upper production zone of said Biogae, wherein the portion of said transparent enclosure within said upper production zone is waterproof, a light source positioned within said transparent enclosure, an agitator positioned within said upper production zone of said Biogae, and a selectively openable outlet in said lower harvesting zone of said Biogae.

4. The Biogae of claim 3, comprising a plurality of said combination of said transparent enclosures and said light sources.

5. The Biogae of claim 4, wherein said transparent enclosures are positioned to provide essentially uniform illumination throughout said upper production zone of said Biogae.

6. The Biogae of claim 3, additionally comprising of selectively openable chemical inlet in said upper production zone of said Biogae.
